(19) United States
(12) Patent Application Publication
(10) Pub. No.: US 2001/0035710 A1
(43) Pub. Date: Nov. 1, 2001

(54) Fluorescent lamp

(76) Inventors: Yoko Shimomura, Nara (JP); Masanori Shimizu, Kyoto (JP); Takeshi Arakawa, Kyoto (JP); Yoshinori Tanabe, Osaka (JP)

Correspondence Address: HARNESS, DICKEY & PIERCE, PLC, P.O. BOX 828, BLOOMFIELD HILLS, MI, 48303, US

(21) Appl. No.: 09/814,035

(22) Filed: Mar. 21, 2001

(30) Foreign Application Priority Data
Mar. 24, 2000 (JP) 2000-084266

(51) Int. Cl. H01J 1/62

(52) U.S. Cl. 313/486; 313/487

(57) ABSTRACT

A fluorescent lamp, wherein a chromaticity value (x, y) of a light source color is in a range surrounded by a point A (0.251, 0.343), a point B (0.285, 0.332), a point C (0.402, 0.407) and a point D (0.343, 0.433), includes a phosphor blend in an inner face of a luminous tube, the phosphor blend comprising an antimony and manganese activated calcium halophosphate phosphor, a rare earth phosphor emitting green, and a rare earth phosphor emitting blue or red.

### BACKGROUND OF THE INVENTION

The present invention relates to a fluorescent lamp, in particular, a fluorescent lamp having a high efficiency and giving a perception of a white color.

A conventional fluorescent lamp for general illumination has a light source color in the chromaticity range described in Z9112-1990 “Classification of a fluorescent lamp by light source color and color rendering” in JIS (Japanese Industrial Standard), and has good color rendering. In other words, the conventional fluorescent lamp has a high average color rendering index Ra, which is used as an evaluation of color appearance. The average color rendering index Ra is an index indicating the fidelity of color reproduction of various light colors with respect to color charts under a reference light source (black body radiation, synthetic daylight).

Since the conventional fluorescent lamp for general illumination should have good color rendering, it has been developed with a care that the chromaticity coordinates of the fluorescent lamp should not significantly be away from the Plankian locus in the upward direction (the DUV is on the plus side). On the other hand, a fluorescent lamp having a high efficiency and allowing a minimum level of color recognition, although having a poor color rendering, is disclosed in International Publication No. W097/11480. This fluorescent lamp is developed, aiming at categorical perception of the color (red, orange, yellow, green, blue, violet, pink, brown, white, gray, black) of an illuminated object, and high efficiency, and therefore the fluorescent lamp is intentionally designed to have a large distance from perfect radiator locus on UV coordinates (DUV).

However, the light source color of this high efficiency fluorescent lamp includes a chromaticity range that gives a strong perception of a color, and therefore when this fluorescent lamp is used together with a fluorescent lamp for general illumination, the combination may give sense of incongruity. To alleviate this sense of incongruity, a fluorescent lamp that allows a minimum level of color recognition and gives not so strong perception of a color but a perception of a white color is disclosed in International Publication No. W098/36441. The fluorescent lamp disclosed in this publication is referred to as “new fluorescent lamp” in this specification.

In the new fluorescent lamp, the light source color is shifted so that the DUV is on the plus side to a larger extent than that of the conventional fluorescent lamp for general illumination. Therefore, even if the same phosphor as that for the fluorescent lamp for general illumination is used, the emission efficiency [lm/W] can be raised. This is because when the light source color has a chromaticity value with the DUV on the plus side to a larger extent, a narrow band emission type of rare earth phosphor emitting green having the highest emission efficiency [lm/W] of the phosphors can be contained in a large amount.

Examples of the phosphor for use in the new fluorescent lamp are (1) a combination of a rare earth phosphor emitting green, a rare earth phosphor emitting blue and a rare earth phosphor emitting red; and (2) a combination of a rare earth phosphor emitting green and a wide band emission type calcium halophosphate phosphor that hardly gives a perception of a color. Although the latter has a significantly lower emission efficiency than that of the former, the latter has an advantage in that the lamp price can be reduced. This is because the price of the rare earth phosphor is high, whereas the price of the calcium halophosphate phosphor is low. More specifically, if the weight ratio [%] of the calcium halophosphate phosphor is increased and the weight ratio [%] of the rare earth phosphor is decreased, the price can be low.

However, although the new fluorescent lamp constructed with a combination of the rare earth phosphor emitting green having the highest emission efficiency and the most inexpensive calcium halophosphate phosphor has an advantage in that the price can be reduced, the emission efficiency [lm/W] is significantly reduced to the same level as that of the conventional fluorescent lamp having excellent color rendering. In other words, in the new fluorescent lamp, the advantage of the improvement of the emission efficiency is lost. This is because the emission efficiency [lm/W] of a calcium halophosphate phosphor is lower than that of the rare earth phosphor emitting green, and the emission color is close to white, so that in order to set the light source color of the new fluorescent lamp to be in a desired chromaticity range, the calcium halophosphate phosphor is required to be used in a relatively large amount, compared with the rare earth phosphor emitting green. More specifically, in order to make the greenish light source color due to the effect of the rare earth phosphor emitting green having the highest emission efficiency be more white by the calcium halophosphate phosphor, it is necessary to use a large amount of the calcium halophosphate phosphor having a low emission efficiency [lm/W]. As a result, the emission efficiency of the new fluorescent lamp drops to the same level as that of the conventional fluorescent lamp for general illumination having high color rendering.

### SUMMARY OF THE INVENTION

Therefore, with the foregoing in mind, it is an object of the present invention to provide a fluorescent lamp giving a perception of a white color and having a high efficiency, in addition to allowing the minimum color recognition, almost without increasing the price of the fluorescent lamp.

A fluorescent lamp of the present invention, wherein the chromaticity value (x, y) of the light source color is in the range surrounded by a point A (0.251, 0.343), a point B (0.285, 0.332), a point C (0.402, 0.407) and a point D (0.343, 0.433), includes a phosphor blend in an inner face of a luminous tube, the phosphor blend comprising an antimony and manganese activated calcium halophosphate phosphor, a rare earth phosphor emitting green, and a rare earth phosphor emitting blue or red.

It is preferable that the chromaticity value (x, y) of the light source color of the fluorescent lamp is in a region in which a DUV is at least 10 on a plus side in the range surrounded by the points A, B, C and D.

The chromaticity value (x, y) of the light source color of the fluorescent lamp may be in a region except chromaticity ranges of light color classification of fluorescent lamps of IEC Publ.81 and JIS Z9112 in the range surrounded by the points A, B, C and D.

It is preferable that the chromaticity value (x, y) of the light source color of the fluorescent lamp is in a region in which the correlated color temperature is 4000 kelvins [K] or more in the range surrounded by the points A, B, C and D.

It is preferable that the ratio of a luminous flux a to a whole luminous flux of the fluorescent lamp is 30 to 90%, and the remaining is made up of a luminous flux b, where the luminous flux a is a luminous flux of intensity in the antimony and manganese activated calcium halophosphate phosphor, and the luminous flux b is a sum of a luminous flux of intensity in the rare earth phosphor having a peak wavelength in an emission spectrum of 420 to 470 nm and a luminous flux of intensity in the rare earth phosphor having a peak wavelength in an emission spectrum of 530 to 580 nm.

It is preferable that the ratio of a luminous flux c to a luminous flux b is 0.1 to 15%, and the remaining is made up of a luminous flux d, where the luminous flux c is the luminous flux of intensity in the rare earth phosphor having a peak wavelength in an emission spectrum of 420 to 470 nm, and the luminous flux d is the luminous flux of intensity in the rare earth phosphor having a peak wavelength in an emission spectrum of 530 to 580 nm.

It is preferable that the luminous flux e to a whole luminous flux of a fluorescent lamp is 30 to 90%, and the remaining is made up of a luminous flux f, where the luminous flux e is a luminous flux of intensity in the antimony and manganese activated calcium halophosphate phosphor, and the luminous flux f is a sum of a luminous flux of intensity in the rare earth phosphor having a peak wavelength in an emission spectrum of 530 to 580 nm and a luminous flux of intensity in the rare earth phosphor having a peak wavelength in an emission spectrum of 600 to 650 nm.

It is preferable that the ratio of a luminous flux h to a luminous flux f is 0.1 to 50%, and the remaining is made up of a luminous flux g, where the luminous flux g is the luminous flux of intensity in the rare earth phosphor having a peak wavelength in an emission spectrum of 530 to 580 nm, and the luminous flux h is the luminous flux of intensity in the rare earth phosphor having a peak wavelength in an emission spectrum of 600 to 650 nm.

According to the present invention, the chromaticity value (x, y) of the light source color of the fluorescent lamp of this embodiment is in the range surrounded by the point A (0.251, 0.343), the point B (0.285, 0.332), the point C (0.402, 0.407) and the point D (0.343, 0.433). The fluorescent lamp of the present invention has a phosphor blend in an inner face of a glass tube, the phosphor blend comprising an antimony and manganese activated calcium halophosphate phosphor, a rare earth phosphor emitting green, and a rare earth phosphor emitting blue or red. Therefore, a fluorescent lamp allowing a perception of a white color and a high emission efficiency as well as the minimum color recognition can be provided almost without raising the price of the fluorescent lamp. In other words, a fluorescent lamp having a high efficiency and allowing a perception of a white color can be realized at a low cost.

This and other advantages of the present invention will become apparent to those skilled in the art upon reading and understanding the following detailed description with reference to the accompanying figures.

### BRIEF DESCRIPTION OF THE DRAWINGS

FIG. 1 is a chromaticity diagram for illustrating the x, y chromaticity range of a fluorescent lamp of an embodiment of the present invention.

FIG. 2 is a schematic cross-sectional view showing an example of a structure of a fluorescent lamp of the embodiment of the present invention.

FIG. 3 is a structural diagram of an experimental apparatus used for an experiment to obtain the chromaticity range of a fluorescent lamp of the embodiment of the present invention.

FIG. 4 is a chromaticity diagram showing chromaticity points of light sources (I) to (III) and (j) to (o).

FIG. 5 is a graph showing the relationship between the weight ratio and the luminous flux ratio of a rare earth phosphor (LAP): a calcium halophosphate phosphor (D).

FIG. 6 is a graph showing the relationship between the luminous flux ratio of a rare earth phosphor (LAP): a calcium halophosphate phosphor (D) and the emission efficiency ratio.

FIG. 7 is a chromaticity diagram showing chromaticity points of light sources (I) to (VI) and (r) and (s), and curves (p) and (q) of the same emission efficiency.

FIG. 8 is a chromaticity diagram showing chromaticity points of light sources (I) to (VI) and (u) and (v), and curves (p) and (t) of the same emission efficiency.

### DETAILED DESCRIPTION OF THE INVENTION

The inventors of the present invention made research to improve the emission efficiency of a fluorescent lamp employing combined phosphors of a rare earth phosphor emitting green and a calcium halophosphate phosphor, and found that the emission efficiency can be significantly raised by adding a trace amount of a rare earth phosphor emitting blue or red that does not have so high emission efficiency to the combined phosphors. In other words, the inventors found that when a phosphor emitting blue or red is added, the light source color can be white, even if the amount of the calcium halophosphate phosphor used in a large amount for white color in the conventional constitution is reduced. This approach allows the amount of the rare earth phosphor emitting green to be relatively increased, so that the emission efficiency of the fluorescent lamp can be improved. As a result, it is possible to provide a well-balanced fluorescent lamp having a significantly improved emission efficiency almost without increasing the cost.

Hereinafter, embodiments of the present invention will be described with reference to the accompanying drawings, although the present invention is not limited to the following embodiments.

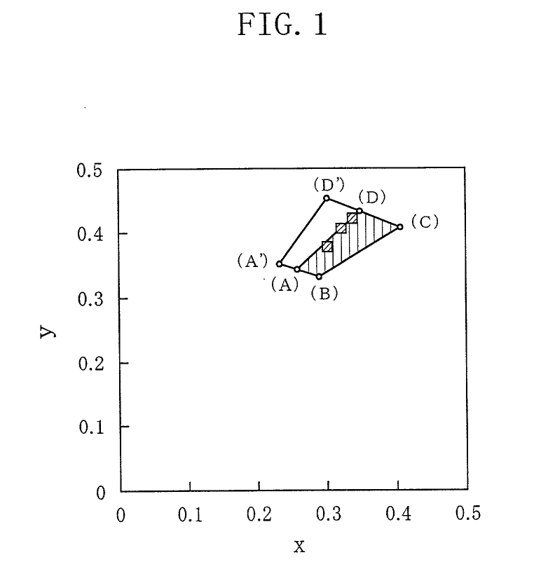

FIG. 1 is a chromaticity diagram for illustrating the chromaticity range of the light source colors of a fluorescent lamp of this embodiment.

The fluorescent lamp of this embodiment has the light source colors defined by the range (the hatched region in the FIG. 1) surrounded by the points A, B, C and D in the chromaticity diagram shown in FIG. 1. In other words, the chromaticity value (x, y) of the light source color of the fluorescent lamp of this embodiment is in the range surrounded by the point A (0.251, 0.343), the point B (0.285, 0.332), the point C (0.402, 0.407) and the point D (0.343, 0.433). The fluorescent lamp of this embodiment has a phosphor blend in an inner face of a luminous tube, the phosphor blend comprising an antimony and manganese activated calcium halophosphate phosphor, a rare earth phosphor emitting green, and a rare earth phosphor emitting blue or red. In other words, the fluorescent lamp of the present invention comprises a calcium halophosphate phosphor and two kinds of rare earth phosphors as the phosphor of the fluorescent lamp.

FIG. 1 also shows the chromaticity range (x, y) of the light source color of the above-described conventional new fluorescent lamp, that is, the range surrounded by point A′ (0.228, 0.351), point B (0.285, 0.332), point C (0.402, 0.407), point D′ (0.295, 0.453). The technique for obtaining the chromaticity range of the light source color of the conventional new fluorescent lamp is disclosed in International Publication No. W098/36441, which is incorporated herein by reference.

The chromaticity range of the conventional new fluorescent lamp was obtained based on the data from an experiment of adding a blue light color to a color produced by a combination of a rare earth phosphor emitting green and a rare earth phosphor emitting red as the base, until the color disappears and a white color is perceived. The chromaticity range of this embodiment of FIG. 1 was obtained based on the data from an experiment of adding a red light color to a color produced by a combination of a rare earth phosphor emitting green and a rare earth phosphor emitting blue as the base, until a white color is perceived.

In the conventional new fluorescent lamp, the chromaticity range appropriate in the correlated color temperature direction is defined, whereas in the fluorescent lamp of this embodiment, the chromaticity range appropriate in the DUV direction is more strictly defined. In other words, in the conventional new fluorescent lamp, a segment A′-B and a segment C-D′ are defined, whereas in the fluorescent lamp of this embodiment, a segment A-D is newly found. Thus, the region that gives a perception that the light is slightly colored in the conventional new fluorescent lamp can be eliminated from the chromaticity range of the fluorescent lamp of this embodiment. As a result, a region that gives a perception of a higher extent of white color is defined. The segment A-D in FIG. 1 was obtained from a plot of the x, y chromaticity value (squared points in FIG. 1) obtained from the experiments of the inventors of the present invention, and is represented by y=0.98x +0.097.

In the chromaticity range shown in FIG. 1, in particular, a region having a DUV of at least 10 on the plus side is preferable for improvement of the emission efficiency. This is because as the DUV is higher on the plus side, a higher emission efficiency can be set. More preferably, the DUV is at least 15 on the plus side, and even more preferably, more than 20 on the plus side.

Furthermore, in the chromaticity range shown in FIG. 1 by the hatched region, the chromaticity ranges of the light source classification of the fluorescent lamps of IEC Publ.81 and JIS Z9112 can be eliminated. By excluding the chromaticity ranges of these light source color classifications, it is possible to achieve an emission efficiency higher than the conventional light source, and a light source color that has never existed before can be realized more distinctly.

In addition, it is preferable that in the chromaticity range shown by the hatched region, a region in which the correlated color temperature is at least 4000 kelvins [K] is preferable. In other words, in order to obtain a higher perception of white color, it is preferable to set the limit value in the correlated color temperature direction to 4000 K as a correlated color temperature, and to produce a fluorescent lamp having a correlated color temperature of any values of not less than the limited value. It is more preferable that the correlated color temperature is 4500 K or more.

The DUVs and the correlated color temperatures of the points A to D are as follows: point A (DUV 42.5 and 10112K), point B (DuV19.2 and 8090K), point C (DUV 7.8 and 3698K), and point D (DUV 36.5 and 5241K).

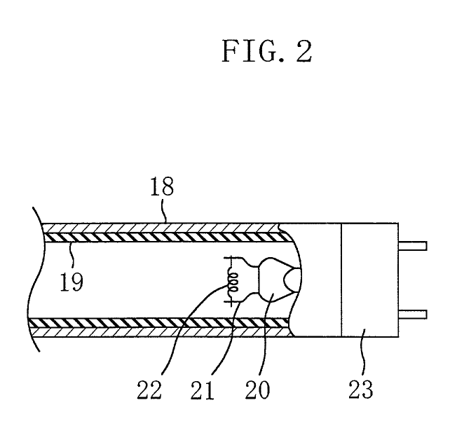

Next, referring to FIG. 2, an example of the structure of the fluorescent lamp of this embodiment will be described. FIG. 2 is a partially cutaway view of the cross-sectional structure of a part of a straight tube fluorescent lamp.

The fluorescent lamp shown in FIG. 2 is a 40w straight tube fluorescent lamp, and has a glass tube (bulb) 18 as a luminous tube of the fluorescent lamp, and a phosphor film 19 applied in the inner surface of the glass tube 18. The phosphor film 19 comprises a blend (a phosphor blend) of an antimony and manganese activated calcium halophosphate phosphor, a rare earth phosphate emitting green, and a rare earth emitting blue or red. The end of the glass tube 18 is closed with a stem 20, and a pair of inner leads 21 extends from the stem 20. Then, a filament electrode 22 is suspended between the ends of the inner leads 21. A lamp base 23 is mounted on the end of the glass tube 18, and the lamp base 23 is electrically connected to the inner lead 21. In this embodiment, the tube is of a straight type, but the tube is not limited thereto, and a bulb type fluorescent lamp or other structures can be used. Furthermore, the luminous tube of the fluorescent lamp is not limited to a glass tube, and a ceramic tube having a high transparency (translucent ceramic tube) can be used.

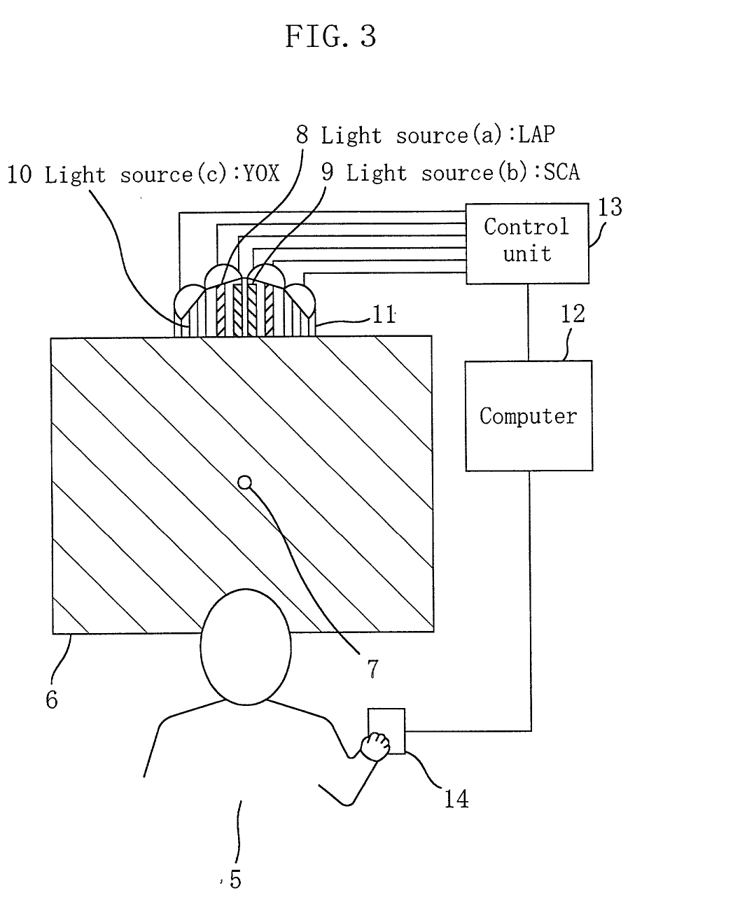

Next, FIG. 3 is referred to. FIG. 3 is a structural diagram of an experimental apparatus used in the experiments to obtain the chromaticity range of the fluorescent lamp of this embodiment.

The experimental apparatus shown in FIG. 3 includes a black light-shielding mask 6 disposed in front of a subject 5, a light source (a) 8, a light source (b) 9, and a light source (c) 10 behind the light-shielding mask 6. An observation emission portion 7 having a line-of-sight dimension of 2 degrees is provided in a position of the height of a line of sight of the subject 5 in the light-shielding mask 6. The light source (a) 8 is LAP (the light color is green, the emission peak wavelength is 543 [nm], the composition of the phosphor is LaPO₄:Ce, Tb). The light source (b) 9 is SCA (the light color is blue, the emission peak wavelength is 452 [nm], the composition of the phosphor is (Sr, Ca, Mg)₅(PO₄)₃Cl:Eu)). The light source (c) 10 is YOX (the light color is red, the emission peak wavelength is 611 [nm], the composition of the phosphor is (Y₂O₃:Eu)). The light radiated from the light sources (a) 8 to (c) 10 are light-controlled by a reflection plate 11, and are designed to be mixed sufficiently. Table 1 shows the x, y chromaticity values of the light sources (a) 8, (b) 9, and (c) 10 used in this experiment.

TABLE 1

| | x | y |
|---|---|---|
| (a) LAP | 0.332 | 0.535 |
| (b) SCA | 0.156 | 0.081 |
| (c) YOX | 0.598 | 0.331 |

Each of the light sources (a) 8, (b) 9, and (c) 10 is connected to a computer 12 via a control unit 13, and the light output of the light sources (a) 8, (b) 9, and (c) 10 can be changed via the control unit 13 in accordance with the signals from the computer 12, independently of each other. The computer 12 is connected to a regulation dial 14 for regulating the light output of the light source (c) 10, and the subject 5 can change the light output of the light source (c) 10 freely.

In this experiment, light sources (d), (e) and (f) having a luminous flux ratio [%] of the light source (a) 8 to (b) 9 of 96:4, 95:5 and 93:7, respectively, were used. Table 2 shows the x, y chromaticity values of the light sources (d), (e) and (f).

TABLE 2

| | LAP: SCA | | |
|---|---|---|---|
| | (Luminous | | |
| | flux) | X | y |
| Light source | 96:4 | 0.294 | 0.436 |
| (d) | | | |
| Light source | 95:5 | 0.287 | 0.417 |
| (e) | | | |
| Light source | 93:7 | 0.274 | 0.383 |
| (f) | | | |

In this experiment, the light sources (d), (e) and (f) were presented at random to the observation emission portion 7, and thereafter the light from the light source (c) 10 is added and mixed until the subject 5 starts to feel that the color is white. Then, the luminous flux ratio [%] of the light sources (a) 8, (b) 9 and (c) 10 were obtained. Three subjects were tested, and one condition was repeated three times. Table 3 shows the average values (the upper row of each section) of the luminous flux ratio of the light sources (a) 8, (b) 9 and (c) 10 at the point when the three subjects started to feel a white color. Table 3 also shows the standard deviation between the subjects in the lower row of each section. The light sources (g), (h) and (i) are light sources having average values of the luminous flux ratios. The light source (g) was obtained by adding and mixing the light from the light source (c) 10 to the light source (d). Similarly, the light source (h) was obtained by adding and mixing the light from the light source (c) 10 to the light source (e). The light source (i) was obtained by adding and mixing the light from the light source (c) 10 to the light source (f).

TABLE 3

| | Luminous flux | Luminous flux | Luminous flux |
|---|---|---|---|
| | of LAP | of SCA | of YOX |
| | (%) | (%) | (%) |
| | Standard | Standard | Standard |
| | deviation | deviation | deviation |
| Light source | 86.6 | 3.7 | 9.7 |
| (g) | 1.34 | 0.28 | 1.01 |
| Light source | 87.4 | 4.6 | 8.0 |
| (h) | 0.88 | 0.09 | 1.18 |
| Light source | 87.4 | 6.0 | 6.6 |
| (i) | 1.00 | 1.77 | 2.88 |

As shown in Table 3, the standard deviation indicating the dispersion of the results of this experiment is small, so that it can be said that the light sources (g), (h) and (i) have the chromaticity that allows all the subjects to feel a white color. The squared points in FIG. 1 are obtained by plotting the x, y chromaticity values of the light sources (g), (h) and (i). The segment A-D in FIG. 1 is a regression line (y=0.98x+0.097) obtained from the x, y chromaticity values of the light sources (g), (h) and (i). Since the light sources (g), (h) and (i) have the chromaticity that allows all the subjects to feel a white color, a fluorescent lamp that gives a perception of colorless and more white color can be realized by achieving the light source color in the hatched portion in FIG. 1.

Next, phosphors for realizing the light source color of the fluorescent lamp of this embodiment will be described.

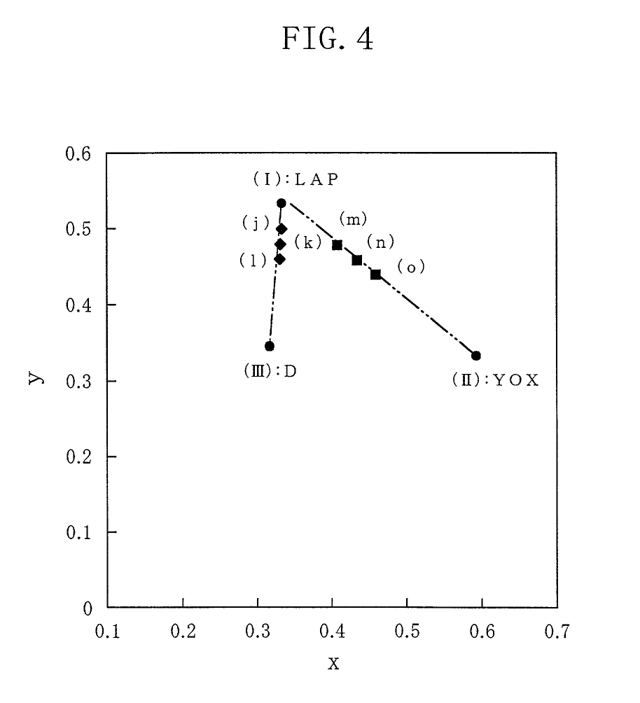

FIG. 4 is a chromaticity diagram for illustrating the chromaticity values of the light source color in the fluorescent lamp of this embodiment. The phosphors of this embodiment are applied onto the inner face of a 40W straight tube fluorescent lamp.

FIG. 4 shows the chromaticity values of light sources (j), (k) and (l) having different weight ratios [%] of the rare earth phosphor (LAP) emitting green and the calcium halophosphate phosphor (D). The color of the light from the calcium halophosphate phosphor (D) is a daylight color, and the composition of the phosphor is 3Ca₃(PO₄)₂·Ca(F, Cl)₂:Sb, Mn. FIG. 4 also shows the chromaticity values of light sources (m), (n) and (o) having different weight ratios [%] of the rare earth phosphor (LAP) emitting green and the rare earth phosphor (YOX) emitting red. In FIG. 4, (I) to (III) are the chromaticity values of the light source colors of single color fluorescent lamps comprising one of the phosphors LAP, YOX and D, respectively.

In the light sources (j), (k) and (l), the weight ratio [%] of the blend phosphor LAP:D that is applied to the fluorescent lamp is 60:40 for (j), 50:50 for (k) and 40:60 for (1). On the other hand, the weight ratio [%] of the blend phosphor LAP:YOX is 60:40 for (m), 50:50 for (n) and 40:60 for (o).

As seen from FIG. 4, for the calcium halophosphate phosphor (D) of whitish light color (daylight color), the change in the chromaticity value of the light source color is small relative to the increase of the weight ratio [%]. On the other hand, for the rare earth phosphor emitting red (YOX), the change in the chromaticity value of the light source color is large relative to the increase of the weight ratio [%]. In other words, compared with D, YOX can change significantly the chromaticity values of the light source color with a small amount. This is because additive mixture of color stimuli can be applied to mixed light, so that light giving a stronger perception of a color affects the change in the chromaticity value of a large extent. This can be true for the rare earth phosphor emitting blue, as in the case of the rare earth phosphor emitting red.

Therefore, when the rare earth phosphor emitting blue or red that allows a large change in the chromaticity value with a small amount, the rare earth phosphor emitting green having the most emission efficiency [lm/W], and the inexpensive calcium halophosphate phosphor are combined, the chromaticity value of the light source color can be adjusted to a large extent.

In the constitution of the phosphor, using a small amount of the calcium halophosphate phosphor, the chromaticity value in the chromaticity region of the hatched portion shown in FIG. 1 can be achieved. However, in this case, an inexpensive fluorescent lamp cannot be provided. In order to realize an inexpensive fluorescent lamp, the weight ratio of the calcium halophosphate phosphor is required to be at least 50%.

When the mixing amount of the calcium halophosphate phosphor is increased to realize an inexpensive fluorescent lamp, the mixing amount of the rare earth phosphor emitting green having a high emission efficiency [lm/W] is reduced relatively, so that the emission efficiency [lm/W] of the fluorescent lamp using the blend phosphor is also reduced. In order to suppress the reduction of the emission efficiency [lm/W] of the fluorescent lamp and to differentiate it from conventional fluorescent lamps for general illumination, it is required to achieve at least 1.1 times the emission efficient of a conventional fluorescent lamp for general illumination comprising a single calcium halophosphate phosphor. The inventors of the present invention produced 40W straight tube type fluorescent lamps having different weight ratios [%] of the rare earth phosphor emitting green (LAP) and the calcium halophosphate phosphor (D) as test lamps, and the range of the optimum luminous flux ratio [%] of the calcium halophosphate phosphor was obtained. It has been found that addition of a trace amount of the rare earth phosphor emitting blue or red can provide an effect of improving the emission efficiency [lm/W]. Therefore, the lower limit of the range of the optimum luminous flux ratio [%] obtained from the test lamps is approximate to the lower limit of the range of the optimum luminous flux [%] of the constitution containing the rare earth phosphor emitting green, the calcium halophosphate phosphor and the rare earth phosphor emitting blue or red.

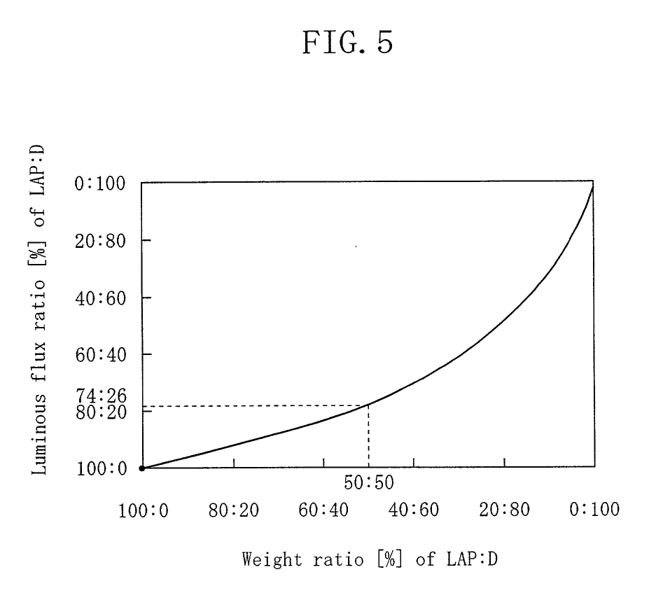

FIG. 5 shows the relationship between the weight ratio [%] and the luminous flux ratio [%] of the rare earth phosphor emitting green (LAP) and the calcium halophosphate phosphor (D). As seen from FIG. 5, in order to achieve at least 50% of the weight ratio of D, it is preferable that the luminous ratio of D should be at least 26%.

Since the calcium halophosphate phosphor comprises antimony (Sb) and manganese (Mn) as activators, when the ratio of these activators is changed, various light colors such as a daylight color (D), a daylight white color (N), a white color (W), a warm white color (WW) can be realized. The inventors of the present invention obtained the relationship as above about light colors other than the daylight color (D). The results were that in order to achieve at least 50% of the weight ratio, it is preferable that the luminous ratio [%] should be 27% for a daylight white color (N), 29% for a white color (W), and 28% for a warm white color (WW). Therefore, in order to achieve at least 50% of the weight ratio, it is preferable that the luminous flux ratio of the calcium halophosphate phosphor should be at least 30%, in view of the dispersion of test lamps.

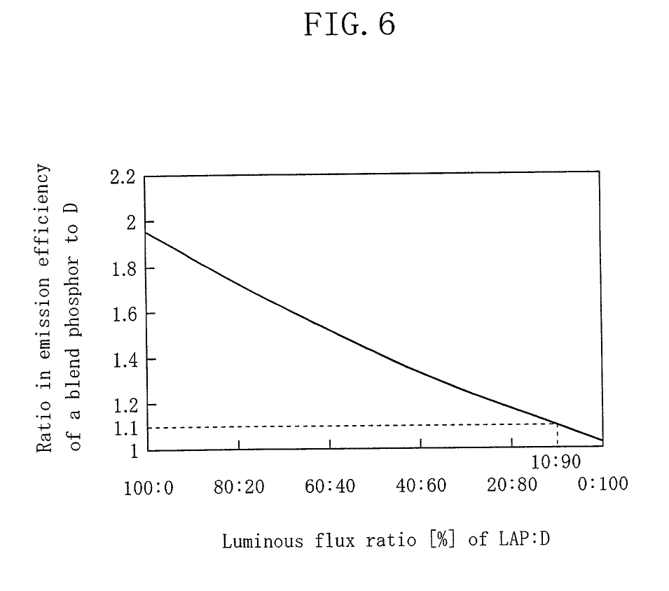

FIG. 6 shows the relationship between the luminous ratio [%] of the rare earth phosphor (LAP) and the calcium halophosphate phosphor (D) and the emission efficiency ratio of the fluorescent lamp comprising the blend phosphor based on the emission efficiency [lm/W] of the fluorescent lamp for general illumination D (a fluorescent lamp comprising the calcium halophosphate phosphor alone).

As seen from FIG. 6, in order to achieve an emission efficiency ratio of 1.1 with respect to the conventional fluorescent lamp for general illumination (D), it is preferable that the luminous flux ratio of the calcium halophosphate phosphor should be 90% or less. In view of the above, it is preferable that the luminous ratio of the calcium halophosphate phosphor should be 30 to 90%, and the remaining is made up of the luminous flux of the two kinds of the rare earth phosphors, that is, the luminous ratio of the two kinds of the rare earth phosphors should be 10 to 70%. It is preferable that the upper limit of the luminous flux ratio [%] of the calcium halophosphate phosphor is for example, 80% or less, more preferably 70% or less, to achieve a higher emission efficiency.

Next, the luminous flux [%] of the two kinds of rare earth phosphors in the fluorescent lamp of the present invention comprising the calcium halophosphate phosphor and the two kinds of rare earth phosphors will be described below.

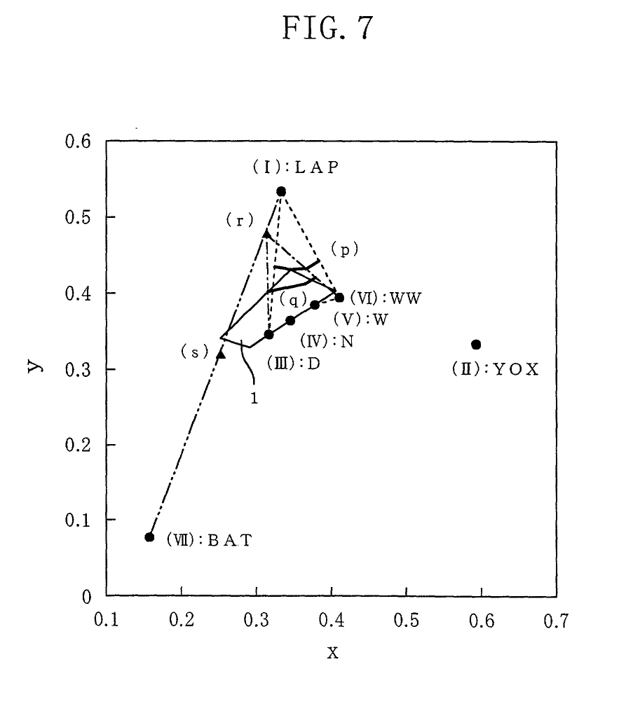

FIG. 7 shows the chromaticity values of the light source color in various light sources having different combinations of phosphors of 40W straight tube fluorescent lamps. A chromaticity region 1 in FIG. 7 corresponds to the hatched portion shown in FIG. 1.

In FIG. 7, (I) to (III) show the chromaticity values of the light source colors of single color fluorescent lamps. The same reference as that in FIG. 4 indicates the same element. (IV) to (VII) show the chromaticity value of the light source color of a single color fluorescent lamps comprising the following phosphor: (IV) a calcium halophosphate phosphor emitting daylight white: N; (V) a calcium halophosphate phosphor emitting white: W; (VI) a calcium halophosphate phosphor emitting warm white: WW; and (VII) a calcium halophosphate phosphor emitting blue: BAT. BAT is a phosphor having an emission peak wavelength of 452 nm and a composition of a BaMgAl₁₀O₁₇:Eu.

In FIG. 7, (r) shows the chromaticity value of the light source color of a fluorescent lamp comprising a blend phosphor of LAP and BAT that are blended so as to achieve a luminous ratio LAP:BAT=98:2 [%]. The chromaticity value of the light source color of the fluorescent lamp comprising the two phosphors that are blended in this manner is positioned on the segment (I) - (VII) connecting the chromaticity values of the signal color fluorescent lamps of the two colors. Therefore, the chromaticity value of the fluorescent lamp comprising the rare earth phosphor: LAP, and the calcium halophosphate phosphor: D, N, W, and WW is in the range surrounded by a segment (I) - (III) connecting (I) LAP and (III) D, a segment (I) - (VI) connecting (I) LAP and (VI) WW, and a curve connecting (III) and (VI).

Curves (p) and (q) are obtained by connecting the chromaticity values of the light source colors that achieve an emission efficiency of 90 lm/W in various light sources having different combinations of phosphors for a 40W straight tube fluorescent lamp. A curve (p) is obtained by connecting the chromaticity values of the light source colors that achieve an emission efficiency of 90 lm/W in the fluorescent lamps comprising a combination of the rare earth phosphor:LAP and each of the calcium halophosphate phosphors: D, N, W, and WW. On the other hand, a curve (q) is obtained by connecting the chromaticity values of the light source colors that achieve an emission efficiency of 90 lm/W in the fluorescent lamps comprising a combination of a phosphor consisting of the rare earth phosphor (LAP) and the rare earth phosphor (BAT) blended to achieve a luminous flux ratio LAP:BAT=98:2 [%] and each of the calcium halophosphate phosphors (D, N, W, and WW).

In the fluorescent lamp comprising these phosphors, the higher the ratio of the rare earth phosphor (LAP) having a high emission efficiency becomes, the higher the emission efficiency of the fluorescent lamp [lm/W] becomes. Therefore, the fluorescent lamp exhibiting the chromaticity value in the region above the curves (p) and (q) (on the side of LAP) has an emission efficiency [lm/W] higher than 90 lm/W. The fluorescent lamp exhibiting the chromaticity value in the region below the curves (p) and (q) has an emission efficiency [lm/W] lower than 90 lm/W.

As shown in FIG. 7, since the curve (p) is above the curve (q), even if the fluorescent lamp comprising a combination of the rare earth phosphor (LAP) and the calcium halophosphate phosphor (D, N, W, and WW) has the same chromaticity value as the chromaticity value allowing 90 lm/W, the fluorescent lamp comprising a combination of the rare earth phosphor (LAP), the rare earth phosphor (BAT) and the calcium halophosphate phosphor (D, N, W, and WW) can achieve an emission efficiency [lm/W] as high as 90 lm/W or more. In other words, in the chromaticity value at which the fluorescent lamp of the present invention comprising a combination of LAP, BAT and calcium halophosphate phosphor (D, N, W, and WW) can achieve 901 m/w, the fluorescent lamp comprising a combination of the rare earth phosphor (LAP) and the calcium halophosphate phosphor (D, N, W, and WW) cannot achieve 90 lm/W and is only less than 901 m/W.

Therefore, the combination of the rare earth phosphor emitting green (LAP), the rare earth phosphor emitting blue (BAT) and calcium halophosphate phosphor (D, N, W, and WW) can achieve an emission efficiency [lm/W] higher than that of the combination of the rare earth phosphor emitting green (LAP) and calcium halophosphate phosphor (D, N, W, and WW) with the same chromaticity value.

In the case of the constitution of the combination of the two rare earth phosphors and the calcium halophosphate phosphor, in order to realize a fluorescent lamp having a chromaticity value of the light source color in the chromaticity region 1, it is preferable that the mixing amount of BAT is set to not more than the mixing amount with respect to (s) in FIG. 7. Since (s) shows the chromaticity value of the light source color of the fluorescent lamp comprising LAP and BAT that are blended in a luminous ratio (LAP:BAT) of 85:15[%], it is preferable that the luminous ratio of BAT is set to 15 or less, and 0.1% or more in view of the mixing accuracy of the phosphors. In other words, it is preferable that LAP and BAT are blended in such a manner that the luminous ratio of BAT is 0.1 to 15%, and the remaining is the luminous ratio of LAP (that is, 99.9 to 85%).

When this luminous ratio [%] is converted to the luminous ratio [%] including emission of the calcium halophosphate phosphor, the luminous ratio of the two rare earth phosphors to the calcium halophosphate phosphor is 10 to 70%, so that the luminous ratio of BAT is 0.01 to 10.5%. Therefore, when a small amount of the rare earth phosphor emitting blue is added to the rare earth phosphor emitting green and the calcium halophosphate phosphor, an inexpensive fluorescent lamp having a high emission efficiency [lm/W] can be realized, almost without changing the amount of the calcium halophosphate phosphor.

When the calcium halophosphate phosphors (III) D and (IV) N are mixed, any chromaticity value on the segment (III) - (IV) can be realized. Furthermore, when the calcium halophosphate phosphors (III) D to (VI) WW are mixed, any chromaticity value on the segment (III) to (VI) can be realized. Therefore, all the chromaticity values in the chromaticity range surrounded by the segment (r)- (III), the segment (r)-(VI), the curve (III) to (VI) can be realized by changing the ratio of LAP, BAT, and the calcium halophosphate phosphor (D, N, W, and WW).

In the above embodiment, the phosphor of BAT emitting strong blue is used, but the phosphor of SCA used in an experiment to obtain a region that allows a perception of a white color, or a phosphor having a composition of BaMgAl₁₀O₁₇:Eu, Mn can be used.

Next, a combination of the rare earth phosphor emitting green (LAP), the rare earth phosphor (YOX) emitting red, a calcium halophosphate phosphor will be described.

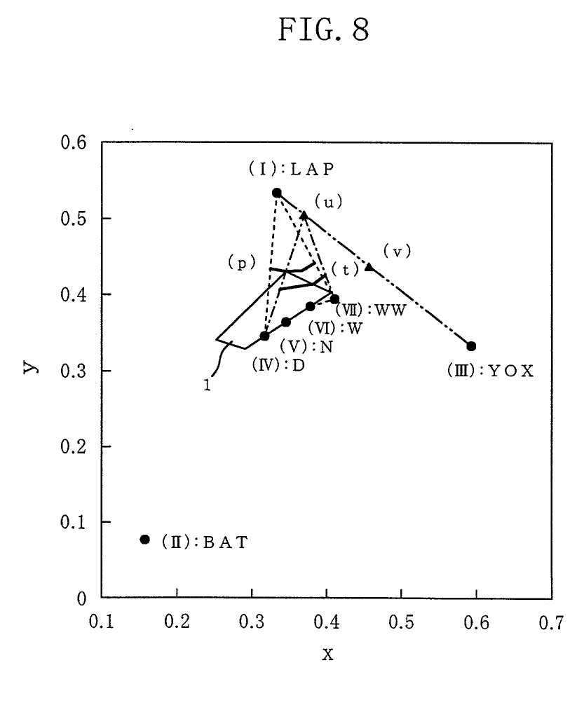

(I) to (VII) in FIG. 8 show the chromaticity values of the light source colors of the same single fluorescent lamps as those of FIG. 7. (u) shows the chromaticity value of the light source color of a fluorescent lamp comprising LAP and YOX blended so as to achieve the luminous ratio LAP:YOX=90:10%. (v) shows the chromaticity value of the light source color of a fluorescent lamp comprising LAP and YOX blended so as to achieve the luminous ratio LAP:YOX=50:50%.

Curves (p) and (t) are obtained by connecting the chromaticity values of the light source colors that achieve an emission efficiency of 90 lm/W in 40W straight tube fluorescent lamps having different combinations of phosphors. A curve (p) is obtained by connecting the chromaticity values of the light source colors emitted from the same combination of the rare earth phosphors as in FIG. 7. On the other hand, a curve (t) is obtained by connecting the chromaticity values of the light source colors emitted from a combination of a blend phosphor comprising the rare earth phosphor (LAP) and the rare earth phosphor (YOX) blended to achieve a luminous flux ratio LAP:YOX=90:10 [%] and each of the calcium halophosphate phosphors (D, N, W, and WW).

In FIG. 8 as well as FIG. 7, the fluorescent lamp having the chromaticity value in the upper region on the LAP side of each curve has a higher emission efficiency, and the fluorescent lamp having the chromaticity value in the lower region has a lower emission efficiency. As seen from FIG. 8, the curve (t) is on the lower side of the curve (p), and therefore, the combination of LAP, YOX and the calcium halophosphate phosphor (D, N, W, and WW) can realize a fluorescent lamp having an emission efficiency higher than that of the combination of LAP and the calcium halophosphate phosphor (D, N, W, and WW) with the same light source color.

Furthermore, it is preferable that the mixing amount of the rare earth phosphor (YOX) emitting red is not more than the mixing amount with respect to (v) to set the chromaticity value of the light source color in the fluorescent lamp comprising the two rare earth phosphors and the calcium halophosphate phosphor in the chromaticity region 1. (v) shows the chromaticity value of light source color of the fluorescent lamp comprising LAP and YOX that are blended in a luminous ratio (LAP:YOX) of 50:50[%], and therefore it is preferable that the luminous ratio of YOX is set to 50% or less, and 0.1% or more in view of the mixing accuracy of the phosphors. In other words, it is preferable that LAP and YOX are blended in such a manner that the luminous ratio of YOX is 0.1 to 50%, and the remaining is the luminous ratio of LAP (that is, 99.9 to 50%).

When this luminous ratio [%] is converted to the luminous ratio [%] including emission of the calcium halophosphate phosphor, the luminous ratio of the two rare earth phosphors to the calcium halophosphate phosphor is 10 to 70%, so that the luminous ratio of YOX is 0.01 to 35%. Therefore, when a small amount of the rare earth phosphor emitting red (YOX) is added to the rare earth phosphor emitting green and the calcium halophosphate phosphor, an inexpensive fluorescent lamp having a high emission efficiency [lm/W] can be realized, almost without reducing the amount of the calcium halophosphate phosphor.

As a phosphor having a peak wavelength in the emission spectrum of 530 to 580 nm, a phosphor having a composition of CeMgAl₁₁O₁₉:Tb can be used.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A fluorescent lamp, wherein a chromaticity value (x, y) of a light source color is in a range surrounded by a point A (0.251, 0.343), a point B (0.285, 0.332), a point C (0.402, 0.407) and a point D (0.343, 0.433),
the fluorescent lamp comprising a phosphor blend in an inner face of a luminous tube, the phosphor blend comprising an antimony and manganese activated calcium halophosphate phosphor, a rare earth phosphor emitting green, and a rare earth phosphor emitting blue or red.

2. The fluorescent lamp according to claim 1, wherein the chromaticity value (x, y) of the light source color of the fluorescent lamp is in a region in which a DUV is at least 10 on a plus side in the range surrounded by the points A, B, C and D.

3. The fluorescent lamp according to claim 1, wherein the chromaticity value (x, y) of the light source color of the fluorescent lamp is in a region except chromaticity ranges of light color classification of fluorescent lamps of IEC Publ.81 and JIS Z9112 in the range surrounded by the points A, B, C and D.

4. The fluorescent lamp according to claim 1, wherein the chromaticity value (x, y) of the light source color of the fluorescent lamp is in a region in which a correlated color temperature is 4000 kelvins [K] or more in the range surrounded by the points A, B, C and D.

5. The fluorescent lamp according to claim 1, wherein a ratio of a luminous flux a to a whole luminous flux of the fluorescent lamp is 30 to 90%, and the remaining is made up of a luminous flux b,
where the luminous flux a is a luminous flux of intensity in the antimony and manganese activated calcium halophosphate phosphor, and the luminous flux b is a sum of a luminous flux of intensity in the rare earth phosphor having a peak wavelength in an emission spectrum of 420 to 470 nm and a luminous flux of intensity in the rare earth phosphor having a peak wavelength in an emission spectrum of 530 to 580 nm.

6. The fluorescent lamp according to claim 5, wherein a ratio of a luminous flux c to a luminous flux b is 0.1 to 15%, and the remaining is made up of a luminous flux d,
where the luminous flux c is the luminous flux of intensity in the rare earth phosphor having a peak wavelength in an emission spectrum of 420 to 470 nm, and the luminous flux d is the luminous flux of intensity in the rare earth phosphor having a peak wavelength in an emission spectrum of 530 to 580 nm.

7. The fluorescent lamp according to claim 1, wherein a ratio of a luminous flux e to a whole luminous flux of a fluorescent lamp is 30 to 90%, and the remaining is made up of a luminous flux f,
where the luminous flux e is a luminous flux of intensity in the antimony and manganese activated calcium halophosphate phosphor, and the luminous flux f is a sum of a luminous flux of intensity in the rare earth phosphor having a peak wavelength in an emission spectrum of 530 to 580 nm and a luminous flux of intensity in the rare earth phosphor having a peak wavelength in an emission spectrum of 600 to 650 nm.

8. The fluorescent lamp according to claim 7, wherein a ratio of a luminous flux h to a luminous flux f is 0.1 to 50%, and the remaining is made up of a luminous flux g,
where the luminous flux g is the luminous flux of intensity in the rare earth phosphor having a peak wavelength in an emission spectrum of 530 to 580 nm, and the luminous flux h is the luminous flux of intensity in the rare earth phosphor having a peak wavelength in an emission spectrum of 600 to 650 nm.
